(19) United States
(12) Patent Application Publication
(10) Pub. No.: US 2024/0270165 A1
(43) Pub. Date: Aug. 15, 2024

(54) CLEAR SHOT EXTERIOR SIDE VIEW MIRROR

(71) Applicant: Morris Classic Concepts, Greenville, SC (US)

(72) Inventor: Billy Morris, Greenville, SC (US)

(73) Assignee: Morris Classic Concepts, Greenville, SC (US)

(21) Appl. No.: 18/642,908

(22) Filed: Apr. 23, 2024

Related U.S. Application Data
(63) Continuation-in-part of application No. 14/090,286, filed on Feb. 18, 2014.

(51) Int. Cl. B60R 1/06

(52) U.S. Cl. CPC B60R 1/06

(57) ABSTRACT

Described herein are clear shot exterior side view mirrors that are unique because the angles of the mirror base where the mirror affixment structure mounts, as well as the angle of the mirror spacer plate under the base, maximize inward adjustability of each mirror affixment structure, eliminating the passenger side blind spot that exists in standard mirrors currently on the market. The two screws in the back of each mirror head stabilize and keep the mirror in its adjusted position eliminating the problem of the mirror repeatedly falling or angling downward when driving.

### PRIORITY CLAIM

This application is a continuation-in-part of parent application Ser. No. 14/090,286 from which priority is claimed, the contents of this application is hereby incorporated by reference in its entirety.

### TECHNICAL FIELD

The subject matter disclosed herein is generally directed to an exterior side view vehicle door mirror that is unique because the angles of the mirror base where the mirror affixment structure mounts, as well as the angle of the mirror spacer plate under the base, maximize inward adjustability of each mirror affixment structure, eliminating the passenger side blind spot that exists in standard mirrors currently on the market. The two screws in the back of each mirror head stabilize and keep the mirror in its adjusted position eliminating the problem of the mirror repeatedly falling or angling downward when driving.

### BACKGROUND

In general, automobiles are typically equipped with an interior rearview mirror assembly (adapted for providing a rearward field of view immediately rearward of the vehicle, typically principally in the road lane the vehicle is traveling in) and two exterior side view mirrors attached to the side of the vehicle (typically adjacent a front side window portion). The exterior side view mirror assembly typically comprises a reflective element adapted to provide a rearward field of view of the side lane adjacent the vehicle so as to allow the driver see whether a side approaching vehicle is present when the driver is contemplating a lane change. Conventionally, automobiles are equipped with a driver-side exterior mirror assembly and a passenger-side exterior side view mirror assembly mounted to the side of the automobile body opposite to that of the driver-side assembly. While a three-mirror system comprising an interior rearview mirror with a driver-side exterior mirror and a passenger-side exterior mirror works well in many driving situations, rear vision blind spots present a potential safety hazard while driving. A rear vision blind spot is an area adjacent the side of an automobile where a view of another vehicle (overtaking on that side) is not captured in the rearward field of view of the exterior mirror reflector on that side. This presents a potential safety hazard as the driver, upon checking the view in the exterior side view mirror and seeing no overtaking vehicle therein, may deem it safe to initiate a lane change, unaware that there is a vehicle immediately adjacent in a blind-spot of the exterior mirror reflector.

Various attempts have been made conventionally to minimize and/or eliminate exterior mirror blind-spots on vehicles. One approach is to make the exterior mirror reflector larger, and particularly wider with respect to the vehicle body. By increasing the width of the exterior mirror reflector, it has a wider field of view rearwards, and hence the reflector blind-spot is reduced. While use of a wide exterior mirror reflector is an option for trucks, buses and commercial vehicles, increasing the width of the reflector used in an exterior side view mirror assembly mounted on automobiles (such as sedans, station wagons, sports cars, convertibles, minivans, sports utility vehicles, pick-up trucks and similar passenger carrying automobiles) is often not an option. In such domestic automobiles, increasing the width of the exterior mirror reflector increases the size of the exterior side view mirror assembly with a concomitant increase in aerodynamic drag, increase in fuel consumption, increased difficulty in parking in tight parking spaces, and increased reflector vibration. Use of a non-flat, curved exterior mirror reflector is commonly used to increase rearward field of view without increasing reflector size.

While working well to increase field of view, use of a curved reflector (such as a convex, spherically-curved reflector) has disadvantages. The field of view rearward increases as the degree of curvature of the bent substrate increases (i.e., the field of view rearward increases as the radius of curvature of the bent substrate decreases). However, such wide-angle mirrors have non-unit magnification and distance perception rearward is distorted. For this reason, convex (spherically-bent) exterior mirror reflectors are required in some countries (such as the United States) to carry a safety warning “OBJECTS IN MIRROR ARE CLOSER THAN THEY APPEAR”. Distance perception is particularly important for a driver-side exterior mirror. Indeed, Federal Vehicle Safety Standard No: 111 in the United States (the entire disclosure of which is hereby incorporated by reference herein) requires that the driver-side exterior mirror reflector exhibit unit magnification, and places restrictions on the radius of curvature allowed for any bent passenger-side mirror as well as requiring a safety warning be placed thereon. As an improvement over spherically bent/convex mirror reflectors, aspherical or multiradius mirror reflectors (such as are disclosed in U.S. Pat. Nos. 4,449,786 and 5,724,187, the entire disclosures of which are hereby incorporated by reference herein) have been developed. Such mirrors are widely used in Europe and Asia for both driver-side exterior mirror reflectors and for passenger-side exterior mirror reflectors. The aspherical or multiradius mirror reflectors typically have a less curved (larger radius of curvature) reflective region that is inboard or closest to the driver when mounted on a vehicle and, usually separated by a demarcation line or the like, have a more curved (smaller radius of curvature) region that is outboard or farthest from the driver when mounted on a vehicle. However, such aspherical or multiradius reflectors do not have unit magnification and so cannot be used when unit magnification is mandated (such as by FMVSS 111, referenced above).

To supplement a flat driver-side exterior mirror reflector, an auxiliary and separate bent reflector is sometimes incorporated into the driver-side exterior side view mirror assembly. However, this is often not suitable for passenger automobiles because of the extra space required in the side view mirror assembly to accommodate an auxiliary reflector element. Also, in most passenger automobiles, the position of the side view mirror reflector is adjustable by the driver (such as by a hand-adjust, or by a manually adjustable cable such as a Bowden cable or by an electrically operable actuator) in order to provide to that driver his or her desired rearward field of view, which ill-suits use of a separate, auxiliary reflector. Likewise, addition of stick-on blind-spot mirror reflectors onto an automobile exterior side view mirror reflector has disadvantages, including obscuring field of view of the automobile mirror reflector and adding to mirror element vibration.

There is thus a need to provide an automobile exterior side view mirror that overcomes the disadvantages above and that provides the driver of the automobile with a distortion-free field of view with a wide-angle view of a side lane blind spot, and there is a need that this be provided in a geometric design suitable to mount onto the vehicle and be adjusted by the driver as needed.

Citation or identification of any document in this application is not an admission that such a document is available as prior art to the present disclosure.

### SUMMARY

The above objectives are accomplished according to the present disclosure by providing in one embodiment, a way to increase visibility and eliminate blind spots in a vehicular side view mirror. The exterior side view mirror system comprises a mirror base that is affixed to a spacer plate. The mirror base is affixed to the spacer plate with a mirror base mounting bracket. The mirror base further comprises a first angled surface and a second angled surface. The first angled surface and the second angled surface extend from the mirror base and are configured opposite to one another. Further, the mirror base comprises a mirror support neck, which is enclosed by the first angled surface and the second angled surface. Still further, the mirror base comprises a mirror affixment structure; wherein the mirror affixment structure is configured to connect to the mirror base by a mirror affixment structure connection. The exterior side view mirror system also comprises a mirror head, wherein the mirror head is configured to attach to the mirror base by a threaded ball stud. Further, the exterior side view mirror system comprises a mirror head mounting bracket, wherein the mirror head mounting bracket is configured to keep the mirror head stable by two mirror head mounting screws. Further again, the mirror base defines a mirror base screw opening, wherein the mirror base screw opening is configured as a threaded hole. Further again, the mirror affixment structure defines a threaded ball stud opening, wherein the threaded ball stud opening is configured as a threaded hole. Still further, the mirror affixment structure is shaped as a column, polygon, or hollow rectangle shape. Moreover, the mirror affixment structure, the mirror support neck, and the mirror base body are configured to form a center line and are configured with an angle ranging from 0 degrees to 60 degrees. Still again further, the spacer plate is configured to be tapered and is configured to be thicker on the proximal end of the mirror base and thinner on the distal end of the mirror base. Further again, the mirror head mounting bracket is configured to connect the mirror head to the mirror base. Further still, the mirror base mounting bracket is configured to connect the mirror base to the spacer plate.

In a further instance, an exterior side view mirror system is formed. The exterior side view mirror system formation may include a spacer plate, a mirror base affixed to a spacer plate, a mirror base mounting bracket affixed between the spacer plate and the mirror base. Further the mirror base may be formed by a first angled surface and a second angled surface, wherein the first angled surface and the second angled surface are configured to extend from the at least one mirror base and are configured opposite one another. Still further, the mirror base is formed by a mirror support neck, wherein the mirror support neck is configured to be enclosed by the first angled structure and the second angled structure. Further again, the mirror base is formed by a mirror affixment structure, wherein the mirror affixment structure is configured to connect to the mirror base by the mirror affixment structure connection. Still yet, the exterior side view mirror system is formed by a mirror head and a threaded ball stud, wherein the threaded ball stud is configured to attach to the mirror head to the mirror base. Further still, the exterior side view mirror system is formed by a mirror head mounting bracket, wherein the mirror head mounting bracket is configured to keep the mirror head stable by two mirror head mounting screws. Further, the mirror base is configured to define a mirror base screw opening, wherein the mirror base screw opening is configured as a threaded hole. Further again, the mirror affixment structure is configured to define at least one threaded ball stud opening, wherein the threaded ball stud opening is configured as a threaded hole. Further, the mirror affixment structure is configured to be shaped as a column, polygon, or hollow rectangle. Still yet, the mirror affixment structure, the mirror support neck, and the mirror base body are configured to form a center line and are configured with an angle ranging from 0 degrees to 60 degrees. Moreover, the spacer plate is configured to be tapered and is configured to be thicker on the proximal end of the mirror base and thinner on the distal end of the mirror base. Again further, the mirror head mounting bracket is configured to connect the mirror head to the mirror base. Further still, the mirror base mounting bracket is configured to connect the mirror base to the spacer plate.

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the present disclosure will be obtained by reference to the following detailed description that sets forth illustrative embodiments, in which the principles of the disclosure may be utilized, and the accompanying drawings of which:

FIG. 1 depicts the side view of the clear shot mirror's base with mirror affixment structure mounted, showing the angle change of the hole where the mirror head mounts to the mirror base.

FIG. 2 depicts the front view of the clear shot mirror's base and the mirror affixment structure mounted to it.

FIG. 3 shows the back view of the clear shot mirror's base and the mirror affixment structure mounted to it.

FIG. 4 shows the clear shot mirror's base from the left side view.

FIG. 5 shows the clear shot mirror's base from the right side view.

FIG. 6 shows the top view of the clear shot mirror's spacer plate, which will be used under the mirror base.

FIG. 7 shows the bottom view of the clear shot mirror's spacer plate with the mounting bracket attached.

FIG. 8 depicts the clear shot mirror's spacer plate from the side view, clearly showing how it is angled.

FIG. 9 depicts the side view of the clear shot mirror's base with mirror affixment structure mounted to it and the threaded ball stud positioned in the mirror affixment structure.

FIG. 10 depicts a mirror head mounting bracket from the top view.

FIG. 11 depicts the clear shot mirror's mirror head mounting bracket from the side view, clearly showing the angling of the two raised arms.

FIG. 12 depicts the clear shot mirror's mirror head from the top view.

FIG. 13 depicts the clear shot mirror's mirror head from the back view.

FIG. 14 depicts the clear shot mirror's base from the bottom view.

FIG. 15a depicts the clear shot mirror's spacer plate with the mounting bracket sitting on top.

FIG. 15b depicts the clear shot mirror's mirror base above and the spacer plate below with the mounting bracket sitting on top.

The figures herein are for illustrative purposes only and are not necessarily drawn to scale.

### DETAILED DESCRIPTION OF THE EXAMPLE EMBODIMENTS

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range is expressed, a further embodiment includes from the one particular value and/or to the other particular value. The recitation of numerical ranges by endpoints includes all numbers and fractions subsumed within the respective ranges, as well as the recited endpoints. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the singular forms “a”, “an”, and “the” include both singular and plural referents unless the context clearly dictates otherwise.

As used herein, “about,” “approximately,” “substantially,” and the like, when used in connection with a measurable variable such as a parameter, an amount, a temporal duration, and the like, are meant to encompass variations of and from the specified value including those within experimental error (which can be determined by e.g., given data set, art accepted standard, and/or with e.g., a given confidence interval (e.g., 90%, 95%, or more confidence interval from the mean), such as variations of +/−10% or less, +/−5% or less, +/−1% or less, and +/−0.1% or less of and from the specified value, insofar such variations are appropriate to perform in the disclosure. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “optional” or “optionally” means that the subsequent described event, circumstance or substituent may or may not occur, and that the description includes instances where the event or circumstance occurs and instances where it does not.

As used herein, “polymer” refers to molecules made up of monomers repeat units linked together. “Polymers” are understood to include, but are not limited to, homopolymers, copolymers, such as for example, block, graft, random and alternating copolymers, terpolymers, etc. and blends and modifications thereof. “A polymer” can be a three-dimensional network (e.g., the repeat units are linked together left and right, front and back, up and down), a two-dimensional network (e.g., the repeat units are linked together left, right, up, and down in a sheet form), or a one-dimensional network (e.g., the repeat units are linked left and right to form a chain). “Polymers” can be composed, natural monomers or synthetic monomers and combinations thereof. The polymers can be biologic (e.g., the monomers are biologically important (e.g., an amino acid), natural, or synthetic.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment”, “an embodiment,” “an example embodiment,” means that a particular feature, structure or characteristic described in connection with the embodiment is included in at least one embodiment of the present disclosure. Thus, appearances of the phrases “in one embodiment,” “in an embodiment,” or “an example embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the disclosure. For example, in the appended claims, any of the claimed embodiments can be used in any combination.

All patents, patent applications, published applications, and publications, databases, websites and other published materials cited herein are hereby incorporated by reference to the same extent as though each individual publication, published patent document, or patent application was specifically and individually indicated as being incorporated by reference.

### KITS

Any of the clear shot exterior side view mirrors described herein can be presented as a combination kit. As used herein, the terms “combination kit” or “kit of parts” refers to the compounds, compositions, embodiments, and any additional components that are used to package, sell, market, deliver, and/or assemble the combination of elements or a single element, such as the clear shot exterior side view mirrors contained therein. Such additional components include, but are not limited to, packaging, blister packages, wrapping, and the like. When one or more of the compounds, compositions, embodiments, and any additional components described herein or a combination thereof (e.g., a clear shot exterior side view mirror contained in the kit are provided simultaneously, the combination kit can contain a clear shot exterior side view mirror in a single embodiment, such as a single piece unit or in separate combinations, such as a clear shot exterior side view mirror accompanied by hardware to mount it, a rearview mirror, etc., that may be added to or used in conjunction with the clear shot exterior side view mirror. When the compounds, compositions, embodiments, and any additional components described herein or a combination thereof and/or kit components are not provided simultaneously, the combination kit can contain each compound or other component in separate embodiments. The separate kit components can be contained in a single package or in separate packages within the kit.

In some embodiments, the combination kit also includes instructions printed on or otherwise contained in a tangible medium of expression. The instructions can provide information regarding the content of the compounds and/or embodiments, safety information regarding the content of the compounds and embodiments, and/or indications for use for the clear shot exterior side view mirror contained therein. In some embodiments, the instructions can provide directions for assembling the embodiments described herein to a subject in need thereof. In some embodiments, the instructions can provide one or more embodiments of the methods for using the clear shot exterior side view mirror such as any of the methods described in greater detail elsewhere herein.

The current disclosure provides a clear shot mirror. A clear shot mirror is generally comprised of a mirror head, mirror head mounting bracket, threaded ball stud, mirror base, mirror base mounting bracket, and spacer plate. The mirror head attaches to the mirror base by inserting the threaded ball stud into the mirror head and the mirror affixment structure, therefore connecting the two structures. The mirror base attaches to the spacer plate by the mirror base mounting bracket. The mirror base mounting bracket sits in an indention in the spacer plate and then hooks onto the distal end of the base with one of its raised arms and the other raised arm of the mounting bracket has a screw inserted into its arm screw opening and the screw is inserted by way of the mirror base screw opening on the proximal side of the mirror base. Finally, the spacer plate and mirror base mounting bracket attach the whole mirror system to the vehicle door. The clear shot mirror system may be used as an exterior door mirror system on General Motors or other classic vehicle brands. The provided disclosure may be used on a sedan, truck, wagon, SUV, van, convertible, sports car, or other kind of personal transportation. This disclosure provides a car mirror system that will eliminate blind spots while driving, which is imperative when operating a vehicle. In order for there to be no blind spots, the mirror has to sit at a certain angle towards the car and the mirror head needs to be held up so that it does not continuously fall forward. The clear shot mirror discloses two screws in the mirror head that are inserted through an angled mirror head mounting bracket and then attached to the mirror base by connecting the threaded ball stud to the mirror head and the mirror affixment structure. This system allows for the mirror head to be held upright and stay in place. The clear shot mirror also discloses a tapered spacer plate, angled mirror base support neck that attaches to an angled mirror affixment structure, allowing for maximized visibility for the driver.

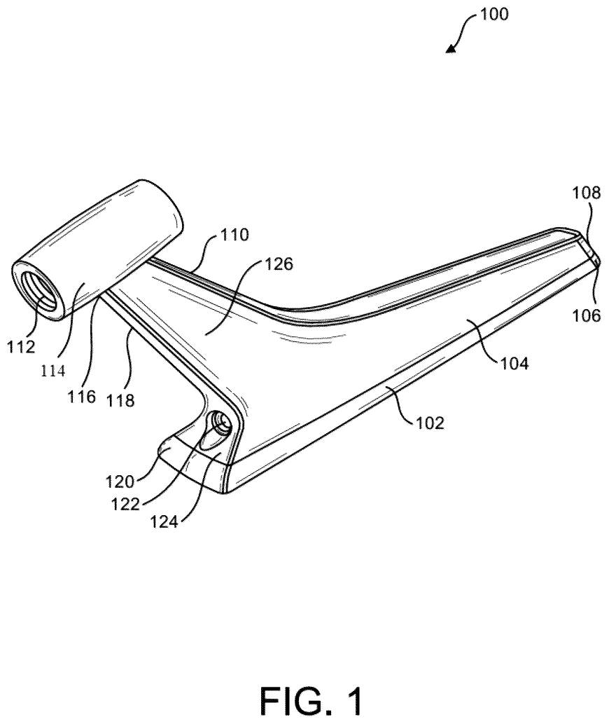

FIGS. 1-5, 8-9, and 14 are illustrative embodiments of the mirror base 100. Mirror base 100 may be shaped as an L-shaped polygon or other polygon that may form an angle and may be configured to support mirror head 804. Mirror base 100 may be made from zinc, silver, aluminum, or other metal plating die cast.

FIG. 1 shows one embodiment of the side of mirror base 100 with no mirror attached. Mirror base 100 may include base body 104, which may extend horizontally from mirror support neck 126, with a proximal end of base 124 closer to mirror support neck 126 and a distal end of base 108 farther from to mirror support neck 126. Base body 104 may range in length from 1.68 inches to 7.68 inches. In one embodiment, base body 104 length dimensions may be 4.68 inches. Base body 104 may define mirror base screw opening 122. Mirror base screw opening 122 may be on the proximal end of base body 104 and below mirror support neck 126. Mirror base screw opening 122 is configured to insert a screw into the threaded hole and through the arm screw opening 1510 on the mirror base mounting bracket. Mirror base 100 may include spacer plate 102 underneath base body 104 with a proximal end of spacer plate 120 closer to mirror support neck 126 and a distal end of spacer plate 106 farther from mirror support neck 126. Spacer plate 102 is configured to be tapered so that it is thicker on the proximal end of spacer plate 120 and thinner on the distal end of spacer plate 106. The purpose of this taper is to angle the mirror inward for maximized visibility. The angle for spacer plate 102 may range from 1 degree to 173 degrees from the top to the bottom of spacer plate 102. In one embodiment, spacer plate 102 may have an angle of 86 degrees. Spacer plate 102 may range in length from 2.82 inches to 6.82 inches, width from 0.04 inches to 1.24 inches for proximal end of spacer plate 120 and 0.43 inches to 1.43 inches for distal end of spacer plate 106, and height of 0.30 inches to 0.70 inches for proximal end of spacer plate 120 and 0.10 inches to 0.40 inches for distal end of spacer plate 106. In one embodiment, mirror base spacer plate length dimensions may be 4.82 inches, width of proximal end of spacer plate 120 may be 0.64 inches, width of distal end of spacer plate 106 may be 0.93 inches, height of proximal end of spacer plate 120 may be 0.50 inches, and height of distal end of spacer plate 106 may be 0.23 inches. Mirror base 100 may include a first angled surface 118 and a second angled surface 110 that may be opposite to each other and may enclose mirror support neck 126. Mirror support neck 126 separates the first angled surface 118 and the second angled surface 110. First angled surface 118 may include the angle ranges from 0 degrees to 60 degrees. In one embodiment, first angled surface 118 may have an angle of 14 degrees from the base body 104 to the threaded ball stud 802. Second angled surface 110 may include the angle ranges from 0 degrees to 60 degrees. In one embodiment, second angled surface 110 may form an angle of 14 degrees from the base body 104 to the threaded ball stud 802. Mirror affixment structure 114 is secured on top of the mirror support neck 126 and forms an angle that allows the mirror head 804 to face the driver operating the vehicle and eliminate blind spots, while also holding the mirror head 804 upright. Mirror affixment structure 114 may shaped as a column, polygon, or hollow rectangle. Mirror affixment structure 114 may have a threaded ball stud opening 112 on the proximal side of base body 104 and affixment structure indentation 302 on the opposing, distal side of base body 104. Mirror affixment structure 114 may range in length from 0.03 inches to 2.83 inches and diameter from 0.14 inches to 1.14 inches and is connected to the mirror base 100 by affixment structure connection 116 and supported by mirror support neck 126. In one embodiment, mirror affixment structure 114 may have a diameter of 0.64 inches and may have a length of 1.43 inches. Mirror affixment structure 114 may include the angle ranges 0 degrees to 60 degrees. In one embodiment, mirror affixment structure 114 may have an angle of 14 degrees. Threaded ball stud opening 112 may be located on the proximal side of base body 104 and allows for a threaded ball stud to be screwed into the threaded hole, holding the mirror head 804 upright and stable. There is a center line that forms between the mirror affixment structure 114, the mirror support neck 126 and the base body 104 that allows the base to be angled correctly for maximized visibility. As stated above, the angle that forms along this center line may range from 0 degrees to 90 degrees, depending on how the structure is configured, to allow for maximized visibility.

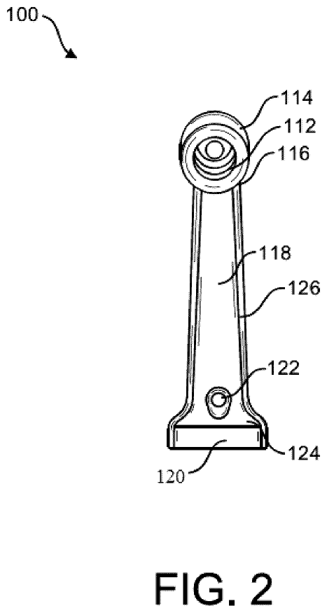

FIG. 2 shows the front view of mirror base 100, with the proximal side of base body 104 visible. In this embodiment, mirror affixment structure 114 is visible, with a view directly into threaded ball stud opening 112. The affixment structure connection 116 may be seen attaching affixment structure 114 to the mirror support neck 126. From this view, only the first angled surface 118 is visible. Mirror base screw opening 122 may be seen below the mirror support neck 126 and defined by of proximal end of base body 104. Proximal end of spacer plate 120 is also visible.

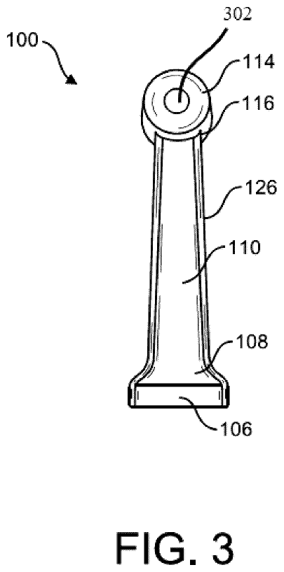

FIG. 3 shows the back view of mirror base 100, with the distal side of base body 104 visible. In this embodiment, mirror affixment structure 114 is visible, with a view directly into affixment structure indentation 302. Affixment structure indentation 302 is included for cosmetic purposes. The affixment structure connection 116 may be seen attaching affixment structure 114 to the mirror support neck 126. From this view, only the second angled surface 110 is visible. Distal end of base body 108 may be seen above distal end of spacer plate 106.

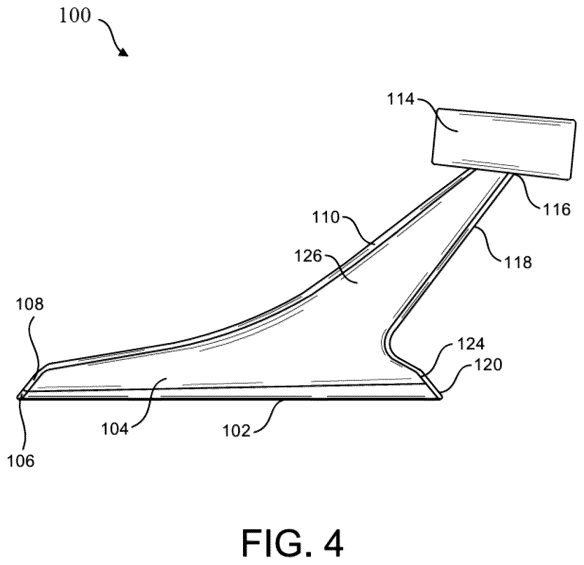

FIG. 4. shows the passenger side of mirror base 100. In this embodiment, mirror affixment structure 114 is visible from the side, with affixment structure connection 116 connecting affixment structure 114 to mirror support neck 126. First angled surface 118 and second angled surface 110 may be seen as separated by mirror support neck 126 and form an angle so the driver visibility is increased and blind spots are eliminated. Base body 104 may be seen above spacer plate 102, with proximal and distal ends of both the base body and spacer plate visible. Spacer plate 102 clearly depicts a taper from the thicker side of proximal end of spacer plate 120 to the thinner side of distal end of spacer plate 106. This taper allows for maximized visibility for driver.

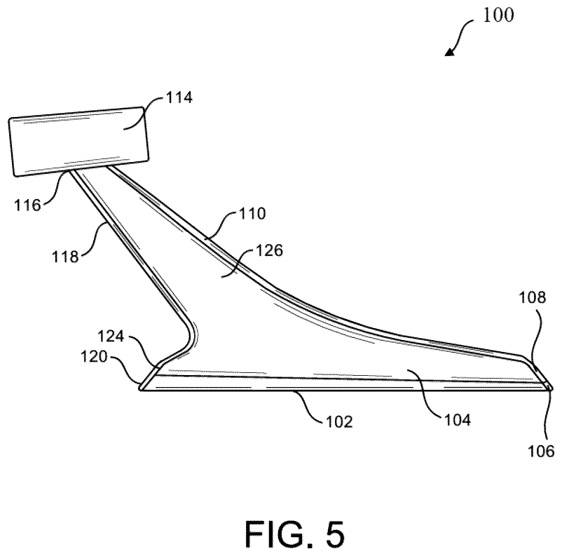

FIG. 5 shows the driver side of mirror base 100. In this embodiment, mirror affixment structure 114 is visible from the side, with affixment structure connection 116 connecting affixment structure 114 to mirror support neck 126. First angled surface 118 and second angled surface 110 may be seen as separated by mirror support neck 126 and form an angle so the driver visibility is increased and blind spots are eliminated. Base body 104 may be seen above spacer plate 102, with proximal and distal ends of both the base body and spacer plate visible. Spacer plate 102 clearly depicts a taper from the thicker side of proximal end of spacer plate 120 to the thinner side of distal end of spacer plate 106. This taper allows for maximized visibility for driver.

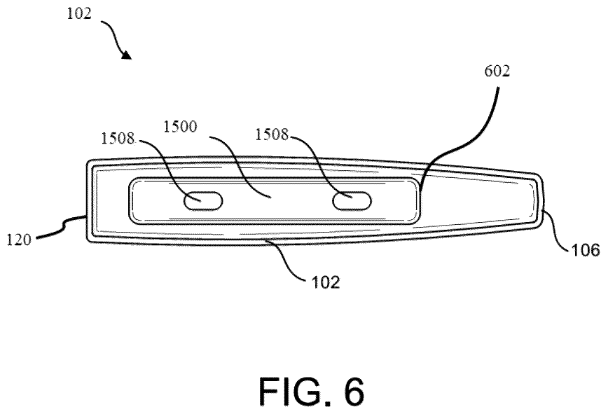

FIG. 6 shows the top view of the spacer plate 102. Spacer plate 102 may be shaped as a rectangle or other polygon. Spacer plate 102 may be a separate structure from mirror base 100 and forms a taper that is pertinent in eliminating blind spots and maximizing driver visibility. The thicker proximal end of spacer plate 120 and the thinner distal end of spacer plate 106 are both visible. From the top, an indentation may be seen on the spacer plate 102. Mirror base mounting bracket 1500 sits inside this spacer plate indentation 602 and allows for mirror base 100 to be connected to the spacer plate 102. Mirror base mounting bracket 1500 has two of mounting hole 1508 that allow screws to be inserted in and pass through the spacer plate 102 and into the vehicle door.

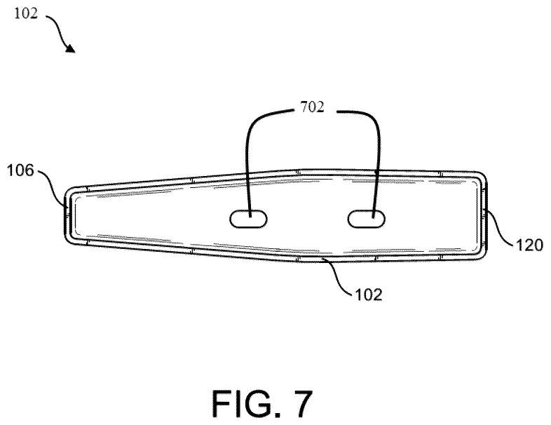

FIG. 7 shows the bottom view of the spacer plate 102 with the proximal end of spacer plate 120 and the distal end of spacer plate 106 both visible. The bottom of spacer plate 102 is the structure that connects the mirror base to the vehicle. Spacer plate hole 702 can be seen in the middle of the spacer plate 102. There may be two of the spacer plate hole 702 and these allow the screws that are inserted in the mounting hole 1508 on the mirror base mounting bracket 1500 to pass through the spacer plate 102 and into the vehicle door. This system between the mirror base mounting bracket 1500 and the spacer plate 102 allows the mirror base 100 to be attached to the vehicle door.

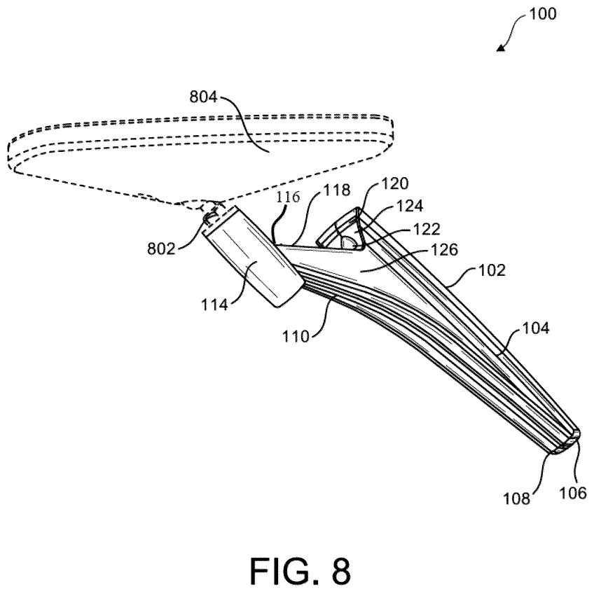

FIG. 8 shows one embodiment of a mirror base 100 from the top with a side view of the Clear Shot Mirror's spacer plate 102, clearly showing how it is angled with mirror 804 attached. Mirror 804 is shown attached to the base body 104 by threaded ball stud 802. Additionally, proximal end of base 124, distal end of base 108, proximal end of spacer plate 120, distal end of spacer plate 106, mirror support neck 126, first angled surface 118, second angled surface 110, mirror base screw opening 122, mirror affixment structure 114, and affixment structure connection 116 are all visible.

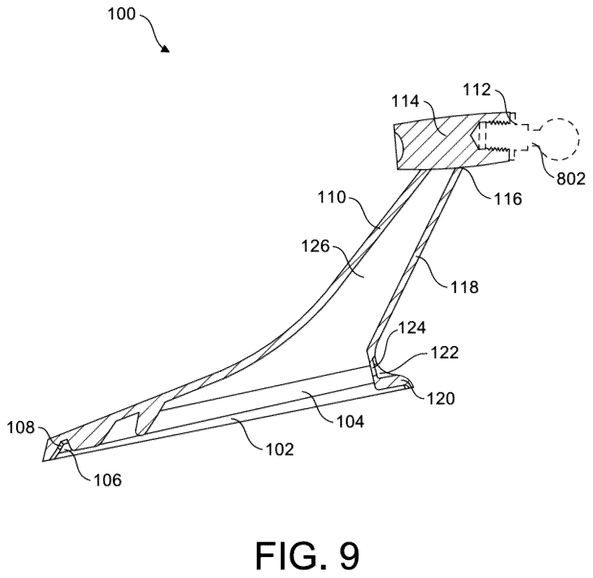

FIG. 9 shows an embodiment of a mirror base 100 with mirror affixment structure 114 attached and threaded ball stud 802 inserted into threaded ball stud opening 112. This figure depicts the angle formed between the threaded ball stud 802 with the first angled surface 118 and the second angled surface 110. Additionally, affixment structure connection 116, mirror support neck 126, base body 104, proximal end of base body 124, distal end of base body 108, spacer plate 102, proximal end of spacer plate 120, and distal end of spacer plate 106 are all visible.

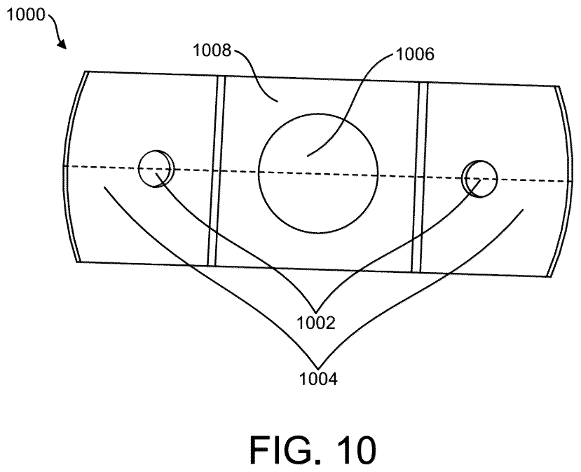

FIG. 10 shows one embodiment of a mirror head mounting bracket 1000. The mirror head mounting bracket 1000 can be shaped as a rectangle or other polygon and may incorporate 3 different square or other polygon shapes. There is an outer arm 1004 on either side of the mirror head mounting bracket 1000. Each outer arm 1004 has a hole 1002 drilled in the middle so that the screws that mount the mirror head to the mirror base can be inserted. The outer arm 1004 on the mirror head mounting bracket sits at an angle that ranges from 1.00 degree to 90.00 degrees. In one embodiment, outer arm 1004 may be 14.35 degrees. The angle in the arms is important for the placement of both the mirror head screws 1204 and the threaded ball stud 802 so that everything fits into place. The middle body 1008 has a spherical or other polygonal formed embossed shape 1006 in the middle to accommodate the threaded ball stud 802. Dimensions for mounting bracket 1000 may range from a length of 0.94 inches to 2.94 inches and a width of 0.10 inches to 1.30 inches. In one embodiment, mounting bracket 1000 may be 1.94 inches in length and 0.70 inches in width.

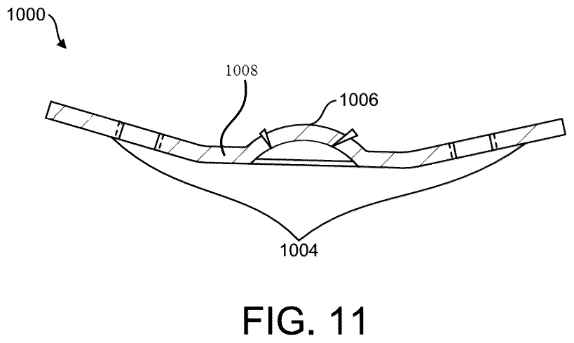

FIG. 11 shows another embodiment of mirror head mounting bracket 1000 from the side view. The mirror head bracket arms 1004 are shown at an angle. This angle allows for the two mirror head mounting screws 1202 to be inserted while also allowing a place for the top of the threaded ball screw 802 to be placed. The middle body 1008 may be shown to have a raised spherical or other polygonal formed shape in the middle to accommodate the threaded ball stud 802.

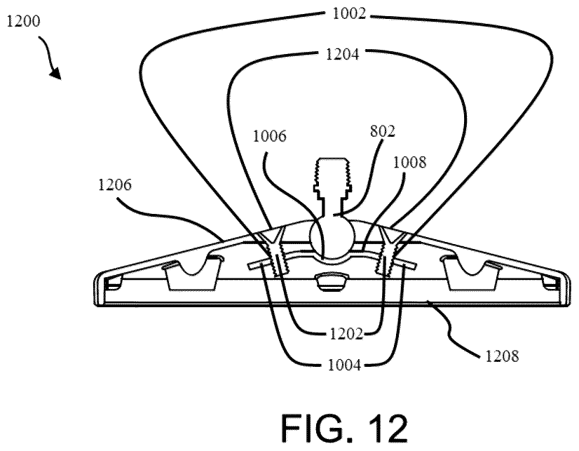

FIG. 12 shows the top view of a mirror head 804. The mirror head 804 may have an anterior side 1208 and a posterior side 1206. This view clearly shows the mirror head mounting bracket 1000 working together with the threaded ball stud 802 and mirror head mounting screw 1202 to attach the mirror head 804 to the mirror base and keep it both upright and stable. The mirror head mounting screws 1202 are screwed through mirror head screw opening 1204 and into hole 1002 on the mirror head mounting bracket. Threaded ball stud 802 may be seen as resting on the formed embossed shape 1006.

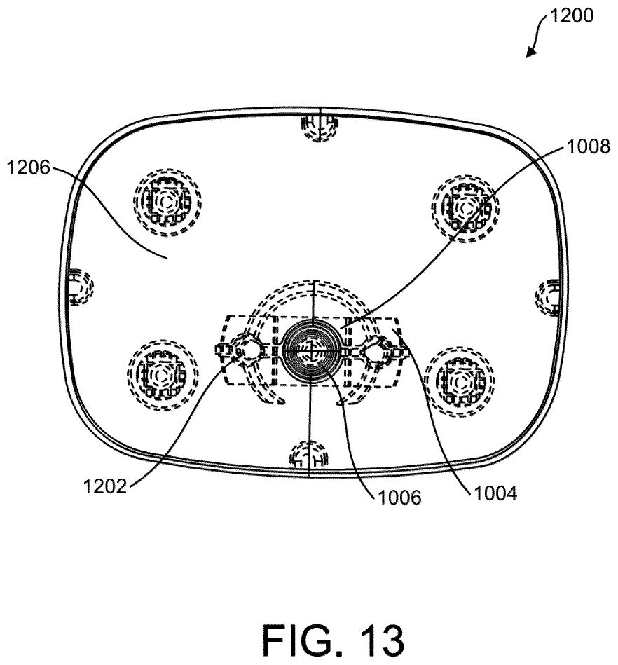

FIG. 13 shows the posterior view of mirror head 804. Posterior side 1206 may include mirror head mounting bracket 1000, mirror head mounting screws 1202, and formed embossed shape 1006 for the threaded ball stud 802 to rest.

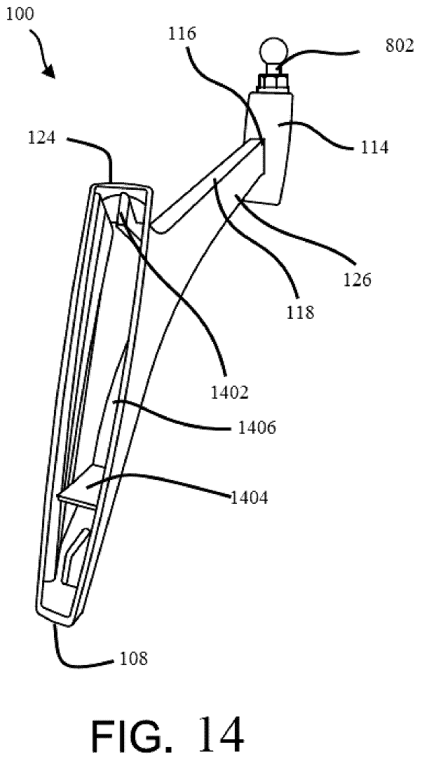

FIG. 14 shows the bottom view of mirror base 100. Mirror base 100 may attach to spacer plate 102 by the mirror base mounting bracket 1500. Base body bottom 1406 may be configured to accommodate the mirror base mounting bracket 1500. As seen in FIG. 14, mirror base screw opening 122 on the proximal end of base body 124 allows for a screw to pass through and subsequently be inserted into raised arm 1506 on the side with the arm screw opening 1510. Oriented on the distal end of base body 108, raised arm 1504 with no screw opening hooks onto wall 1404.

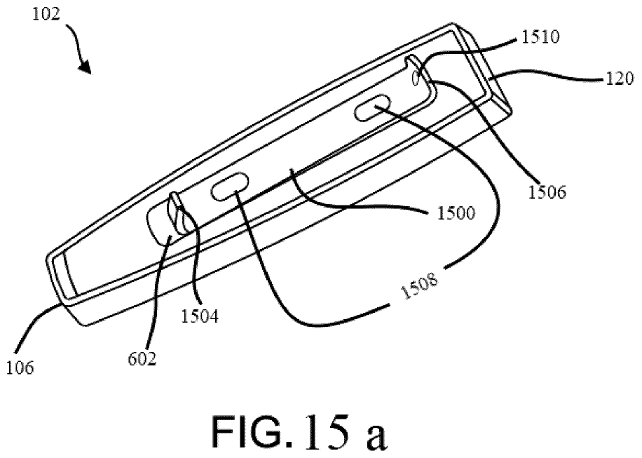

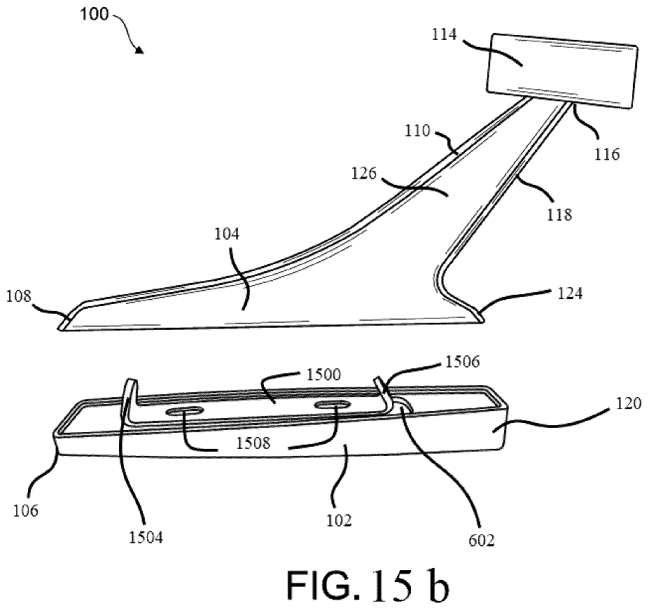

FIG. 15a shows the side view of mirror base mounting bracket 1500. The mirror base mounting bracket 1500 sits in spacer plate indentation 602. Mirror base mounting bracket 1500 may be shaped as a rectangle or other polygon with raised arms on either side of the bracket. Raised arm 1506 is defined by an arm screw opening 1510 and has a screw inserted into it through mirror base screw opening 122 on the proximal side of the mirror base. The mirror base mounting bracket also hooks onto the distal end of base 108 with raised arm 1504. The mounting hole 1508 is configured to attach the mirror base to the car through the spacer plate 102 through the spacer plate hole 702.

FIG. 15b shows the side view of mirror base 100 and spacer plate 102 with mirror base mounting bracket 1500 sitting on top in spacer plate indentation 602. This figure gives a visual of how the spacer plate attaches to the mirror base with the mirror base mounting bracket 1500.

Clear shot mirrors are exterior side view door mirrors that are chrome-plated and designed to mount on General Motor or other classic cars. Clear shot mirrors and spacers are designed to eliminate the blind spot on the passenger side of vehicles, as well as keep the mirror head upright and stable. The design of the clear shot mirror is to ensure that the driver of the vehicle can safely merge into the right lane (if adjusted correctly by the driver beforehand) because it gives a clear view of the right lane beside the car. The geometric design of each clear shot mirror base angles each mirror head inward towards the car, so the center of the mirror is in parallel with the car. This eliminates the common passenger side blind spot that other mirrors have. In addition to this inward adjustability, each clear shot mirror also has a screw-in threaded ball stud that holds each mirror head to each mirror base, and two screws in the back of each mirror head to stabilize and keep it in its adjusted position so it doesn't fall down or angle down when driving. This eliminates another common problem with other mirrors that repeatedly fall down when driving so that the driver can't see the lanes beside the car.

Clear shot mirrors are made in a high-pressure die cast mold out of aluminum, tumbled and polished, then chrome plated. Each clear shot mirror is assembled and ready to put on the car when received with the included mirror bracket, screws, and star/lock washers. First, the mirror base mounting bracket will be bolted onto the exterior of the car in the factory holes on the driver's side of the car. The corresponding holes will need to be made on the passenger's side of the car's exterior, using the holes on the driver's side as a template. The slotted holes in each mirror base mounting bracket will line up with these holes in the car, and once the bracket is installed, the mirror will mount onto the bracket with a screw that goes in through the front of the mirror base and into the bracket underneath/within. The bracket attached to the car securely holds the mirror to the car itself, and the driver can then adjust the alignment of the mirror head by hand. Additional inward adjustability can be achieved (if needed or preferred by the driver) by using an optional spacer underneath each mirror base. The mirror base spacer plate is machined from UHMW plastic in a CNC lathe.

Various modifications and variations of the described methods, compositions, and kits of the disclosure will be apparent to those skilled in the art without departing from the scope and spirit of the disclosure. Although the disclosure has been described in connection with specific embodiments, it will be understood that it is capable of further modifications and that the disclosure as claimed should not be unduly limited to such specific embodiments. Indeed, various modifications of the described modes for carrying out the disclosure that are obvious to those skilled in the art are intended to be within the scope of the disclosure. This application is intended to cover any variations, uses, or adaptations of the disclosure following, in general, the principles of the disclosure and including such departures from the present disclosure come within known customary practice within the art to which the disclosure pertains and may be applied to the essential features herein before set forth.

What is claimed is:

1. An exterior side view mirror system comprising:
at least one mirror base;
at least one mirror base affixed to at least one spacer plate;
at least one mirror base mounting bracket affixed between the at least one spacer plate and the at least one mirror base;
wherein the at least one mirror base further comprises;
at least one first angled surface;
at least one second angled surface;
wherein the at least one first angled surface and the at least one second angled surface extend from the at least one mirror base;
wherein the at least one first angled surface and the at least one second angled surface are opposite to one another;
at least one mirror support neck;
wherein the at least one mirror support neck is configured to be enclosed by the at least one first angled surface and the at least one second angled surface;
at least one mirror affixment structure;
wherein the at least one mirror affixment structure is configured to connect to the at least one mirror base by at least one mirror affixment structure connection;
at least one mirror head;
wherein the at least one mirror head is configured to attach to the at least one mirror base by at least one threaded ball stud;
at least one mirror head mounting bracket; and
wherein the at least one mirror head mounting bracket is configured to keep the at least one mirror head stable by at least two mirror head mounting screws.

2. The exterior side view mirror system of claim 1, wherein the at least one mirror base defines at least one mirror base screw opening.

3. The exterior side view mirror system of claim 2, wherein the at least one mirror base screw opening is configured as a threaded hole.

4. The exterior side view mirror system of claim 1, wherein the at least one mirror affixment structure defines at least one threaded ball stud opening.

5. The exterior side view mirror system of claim 4, wherein the at least one threaded ball stud opening is configured as a threaded hole.

6. The exterior side view mirror system of claim 1, wherein the at least one mirror affixment structure is shaped as a column, polygon, or hollow rectangle shape.

7. The exterior side view mirror system of claim 1, wherein the at least one mirror affixment structure, the at least one mirror support neck, and the at least one mirror base body are configured to form a center line and are configured with an angle ranging from 0 degrees to 60 degrees.

8. The exterior side view mirror system of claim 1, wherein the at least one spacer plate is configured to be tapered and is configured to be thicker on the proximal end of the at least one mirror base and thinner on the distal end of the at least one mirror base.

9. The exterior side view mirror system of claim 1, wherein the at least one mirror head mounting bracket is configured to connect the at least one mirror head to the at least one mirror base.

10. The exterior side view mirror system of claim 1, wherein the at least one mirror base mounting bracket is configured to connect the at least one mirror base to the at least one spacer plate.

11. A method for making an exterior side view mirror system comprising:
forming at least one spacer plate;
forming at least one mirror base affixed to at least one spacer plate;
forming a mirror base mounting bracket affixed between the at least one spacer plate and the at least one mirror base;
wherein the at least one mirror base is configured to comprise;
at least one first angled surface;
at least one second angled surface;
wherein the at least one first angled surface and the at least one second angled surface are configured to extend from the at least one mirror base;
wherein the at least one first angled surface and the at least one second angled surface are configured opposite one another;
at least one mirror support neck;
wherein the at least one mirror support neck is configured to be enclosed by the at least one first angled surface and the at least one second angled surface;
at least one mirror affixment structure;
wherein the at least one mirror affixment structure is configured to connect to the at least one mirror base by at least one mirror affixment structure connection;
forming at least one mirror head;
forming at least one threaded ball stud;
wherein the at least one threaded ball stud is configured to attach to the at least one mirror head to the at least one mirror base;
forming at least one mirror head mounting bracket; and
wherein the at least one mirror head mounting bracket is configured to keep the at least one mirror head stable by at least two mirror head mounting screws.

12. The exterior side view mirror system of claim 11, further comprising forming the at least one mirror base configured to define at least one mirror base screw opening.

13. The exterior side view mirror system of claim 12, further comprising forming the at least one mirror base screw opening configured as a threaded hole.

14. The exterior side view mirror system of claim 11, further comprising forming the at least one mirror affixment structure configured to define at least one threaded ball stud opening.

15. The exterior side view mirror system of claim 14, further comprising forming the at least one threaded ball stud opening configured as a threaded hole.

16. The exterior side view mirror system of claim 11, further comprising forming the at least one mirror affixment structure is configured to be shaped as a column, polygon, or hollow rectangle.

17. The exterior side view mirror system of claim 11, further comprising forming the at least one mirror affixment structure, the at least one mirror support neck, and the at least one mirror base body are configured to form a center line and are configured with an angle ranging from 0 degrees to 60 degrees.

18. The exterior side view mirror system of claim 11, further comprising forming the at least one spacer plate is configured to be tapered and is configured to be thicker on the proximal end of the at least one mirror base and thinner on the distal end of the at least one mirror base.

19. The exterior side view mirror system of claim 11, further comprising forming the at least one mirror head mounting bracket is configured to connect the at least one mirror head to the at least one mirror base.

20. The exterior side view mirror system of claim 11, further comprising forming the at least one mirror base mounting bracket is configured to connect the at least one mirror base to the at least one spacer plate.
